(19) United States
(12) Patent Application Publication
(10) Pub. No.: US 2015/0213564 A1
(43) Pub. Date: Jul. 30, 2015

(54) CONSUMER COOPERATION SUPPORT APPARATUS

(71) Applicant: Hitachi, Ltd., Tokyo (JP)

(72) Inventors: Haruhisa Ishida, Tokyo (JP); Hiroyuki Hori, Tokyo (JP); Akihiro Itoh, Tokyo (JP); Takashi Noguchi, Tokyo (JP)

(73) Assignee: Hitachi, Ltd., Tokyo (JP)

(21) Appl. No.: 14/419,710

(22) PCT Filed: Aug. 27, 2012
(86) PCT No.: PCT/JP2012/071536

§ 371 Date: Feb. 5, 2015

(51) Int. Cl. G06Q 50/06; G06Q 30/02

(52) U.S. Cl. CPC G06Q 50/06; G06Q 30/0204

(57) ABSTRACT

Provided is a consumer cooperation support system in which control requests from a plurality of master consumers do not conflict with each other. A consumer cooperation support apparatus collects attribute information from an EMS group that can collect, manage, and transmit attribute information of ordinary power consumers, and manages the attribute information to manage an identifier of a master consumer EMS group that issues a control request to other consumers by its own judgment. The consumer cooperation support apparatus allocates a cluster obtained by classifying consumers based on the attribute information to a group created so as to correspond to the master consumer EMS. When the master consumer EMS refers to an EMS group in order to issues a control request, the EMS group that can be referred to is limited to EMSs included in the group.

### TECHNICAL FIELD

The present invention relates to a smart grid.

### BACKGROUND ART

In recent years, a photovoltaic power generation device, a wind power generation device, a NAS battery, and an electric vehicle have been widely used by power consumers such as an ordinary household, a building, or a factory. A framework called a smart grid that connects such power generation devices, batteries, and electric devices such as an air-conditioner by a network, monitors the operation state of devices, and interchanges the excess and the shortage in electric power to thereby improve the efficiency of power consumption in a region has been gathering attention.

This framework allows a power distribution company to turn on/off the power of a device and control the output of the device via a network based on the operation data of the device collected via the network. For example, a control request is transmitted to a consumer in a peak power demand hour during the daytime to turn off an air-conditioner possessed by the consumer or change the set temperature thereof upon permission.

In this way, it is possible to suppress the power consumption to be equal to or lower than a maximum power generation amount.

However, since the control target device is a consumer's possession, the control request may be rejected. Due to this, a method of predicting whether a consumer accepts or rejects the control when making a control plan or calculating an incentive required for the control to be accepted by a consumer has been studied.

### CITATION LIST

### Patent Literature

### [PTL 1]

### Japanese Patent Application Publication No. 2008-295193

### SUMMARY OF INVENTION

### Technical Problem

In PTL 1, future power supply and demand data is predicted based on past power supply and demand data and a control plan is made based on the prediction result. In this case, a consumer model made up of an incentive presented to a consumer and a control cooperation level is calculated from the result of past control acceptance and rejection for each consumer. By using the calculation result during control, it is possible to select a consumer having a high cooperation level to perform control and to increase the accuracy of the control result.

Here, PTL 1 assumes that a single entity (an electric power company, power distribution company, or the like) performs control on a certain consumer. However, a community energy management system (CEMS) and a micro-grid proposed in relation with the smart grid propose a framework in which consumers in a community interchange electric power. In this case, the entity that performs control on consumers is not limited to a single electric power company or a single power distribution company, but other consumers also perform the control. Due to this, according to the conventional method which does not take the presence of another entity that performs control into consideration, highly accurate prediction cannot be made.

Specifically, in PTL 1, since it is not possible to take another entity that performs control into consideration when predicting a response to control, there is a problem that a plurality of control operations is performed on one consumer simultaneously. When it is not possible to process a plurality of control operations on one consumer simultaneously, some control operations are rejected. As a result, the result becomes different from prediction and the entity that performs control needs to correct the control plan. As a result, stabilizing the control takes time, which causes a problem in real-time electric power control.

Here, it is considered that, if a contract is made between a control entity and a control subject (consumer or the like) and control operations are exchanged only when the contract is valid, the contract conflict problem can be solved. However, it is considered that, when the range of exchangeable control operations is limited based on the contract only, the properties of the correlated control subject change greatly depending on the control entity. When such an imbalance is present, some of the groups which exchange control operations can be the cause of instability in power control. Specifically, when a consumer (group) is incorporated into power control, it is considered to be desirable that the consumer (group) has sufficient facilities (power generation devices, storage batteries, or the like) and is cooperative to power control (has a high acceptance rate of the control). However, the acceptance rate or the like when a consumer receives a request for control on facilities such as power generation devices or storage batteries possessed by the consumer is different for respective consumers. Due to this, when a control group is determined based on a contract only, a case where some groups do not include a number of consumers sufficient for performing power control stably may occur. Thus, it is not possible to adjust the supply and demand sufficiently in emergencies, which is a hindrance to stable power control.

Therefore, with such a problem in view, an object of the present invention is to prevent control requests from conflicting with each other even when a plurality of control entities is present, increase prediction accuracy of control results to reduce the number of corrections of a control plan, and increase stability of power control. Another object of the present invention is to maintain a situation for maintaining stability of power control.

### Solution to Problem

In order to solve the problem, a consumer cooperation support apparatus creates groups for respective consumers (master consumers) that mainly transmit a control request and manages information on a correspondence between a group and a consumer.

The groups are created in the following manner. First, data such as (i) operation data of various devices possessed by a consumer, (ii) facility data of various devices possessed by a consumer, (iii) a response result to a control request issued to a consumer, and (iv) environment data such as the temperature around a consumer is collected and managed. Subsequently, consumers are modeled based on the collected data and an acceptance rate of a consumer to the control request is calculated. Moreover, consumers are classified into clusters based on the collected data and the modeling result. After that, groups are created so that consumers included in respective clusters are allocated to respective groups according to the proportions of the amounts of facilities possessed by the master consumers.

The master consumer can transmit a control request to a consumer via the consumer cooperation support apparatus. In this case, the candidates for a destination of the control request presented to the master consumer are made up only of consumers included in the group associated with the master consumer. In this manner, electric power is interchanged.

### Advantageous Effects of Invention

A consumer group is created for specific consumers, execution of control requests is limited to such a range of consumers, whereby conflict between control requests can be prevented. Moreover, when groups are created, consumers are clustered once and each cluster is allocated to groups according to the proportions of the amounts of facilities possessed by the master consumers. In this way, the balance between the amount of facilities of the master consumer and the total amount of facilities possessed by the allocated consumers is equalized between groups.

### BRIEF DESCRIPTION OF DRAWINGS

FIG. 1 illustrates a system configuration.

FIG. 2 illustrates a physical configuration.

FIG. 3 illustrates a software configuration.

FIG. 4 illustrates past operation information.

FIG. 5 illustrates facility information.

FIG. 6 illustrates a response to control.

FIG. 7 illustrates management data of a group and a cluster to which a consumer belongs.

FIG. 8 illustrates environment information.

FIG. 9 illustrates analysis results.

FIG. 10 illustrates a flowchart of group management.

FIG. 11 illustrates an image of a group creation process.

FIG. 12 illustrates an image of a process corresponding to an increase in the number of master consumers.

FIG. 13 illustrates an image of a process corresponding to a decrease in the number of master consumers.

FIG. 14 illustrates an image of a process corresponding to an increase in the number of consumers.

FIG. 15 illustrates group data.

FIG. 16 illustrates relay of a control request.

FIG. 17 illustrates contract information.

FIG. 18 illustrates a transformation loss rate of a transformer.

FIG. 19 illustrates a transmission loss rate between transformers nearest to a consumer.

FIG. 20 illustrates a transmission loss rate between transformers.

### DESCRIPTION OF EMBODIMENTS

### Embodiment 1

Hereinafter, an embodiment of the present invention will be described with reference to the drawings.

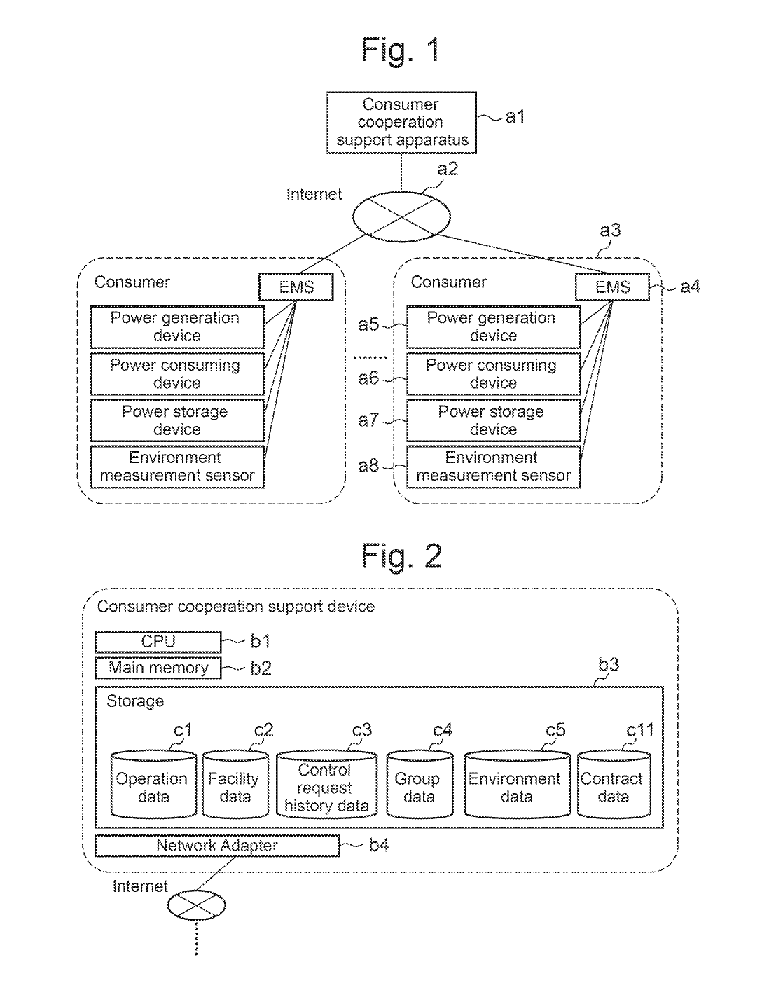

A block diagram illustrating a system configuration will be described with reference to FIG. 1. A consumer cooperation support apparatus a1 is an apparatus for relaying a control request transmitted and received between consumers and grouping the consumers. A consumer a3 is an abstract expression of an electric power user such as an ordinary household, a factory, or a building. It is assumed that the consumer cooperation support apparatus a1 and the consumer a3 can communicate bidirectionally via a network (Internet or the like) 2. Moreover, in FIG. 1, a power generation device a5, a power consuming device a6, and a power storage device a7 are abstract expressions of devices possessed by the consumer a3 and capable of generating, using and storing electric power, and an EMS a4 is a device for managing and controlling these devices and communicating with the consumer cooperation support apparatus a1.

An example of a physical configuration of the consumer cooperation support apparatus a1 will be described with reference to FIG. 2. This device includes an arithmetic unit (CPU) b1, a storage device (a main memory b2 and a hard disk b3), and a network adapter b4 and is connected to the network a2 via the network adapter b4.

Various DBs are stored in the storage device. Specifically, operation data c1, facility data c2, control request history data c3, group data c4, and environment data c5 are stored as DBs.

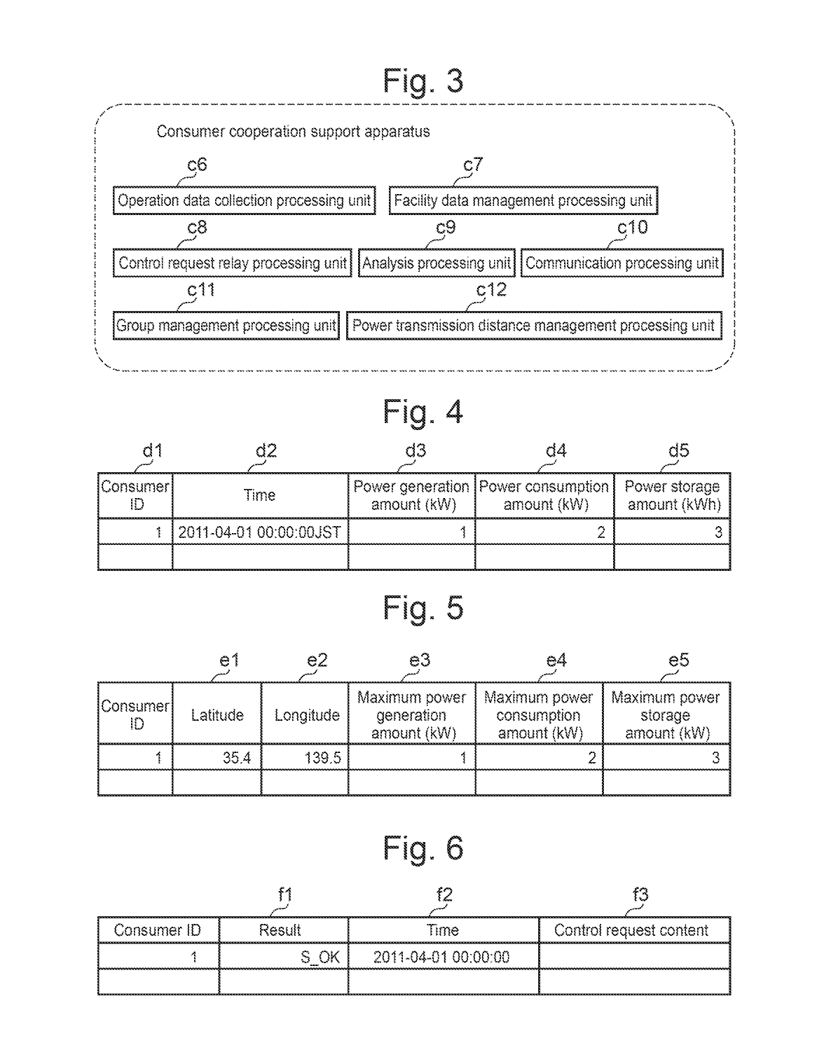

A software configuration of the consumer cooperation support apparatus a1 will be described with reference to FIG. 3. These software components are stored in the storage device and are executed appropriately by the arithmetic unit, whereby the software components function as processing units. This apparatus includes an operation data collection processing unit c6, a facility data management processing unit c7, a control request relay processing unit c8, an analysis processing unit c9, a group management processing unit c11, and a power transmission distance management processing unit c12 as process execution units.

The process execution units communicate with external devices via a communication unit c10.

The format of data managed inside the consumer cooperation support apparatus a1 will be described with reference to FIGS. 4, 5, 6, 7, 8, 9, and 15.

FIG. 4 illustrates the format of data used when managing operation data (past operation information) of devices possessed by a consumer. A consumer ID d1 is an ID that is uniquely determined to be used for identifying a consumer, and time d2 is the time when operation data is acquired. The operation data of a facility possessed by a consumer is represented by three values of a power generation amount d3, a power consumption amount d4, and a power storage amount d5, which are managed in association with a pair of the consumer ID d1 and the time d2. Each entry of this table is added whenever operation data is sent from the EMS a4.

FIG. 5 illustrates the format of data used when managing performance data (facility information) of a device possessed by a consumer. Latitude e1 and longitude e2 represent the place where a facility possessed by a consumer is present. The performance of an device possessed by a consumer is represented by three values of a maximum power generation amount e3, a maximum power consumption amount e4, and a maximum power storage amount e5, which are managed in association with the consumer ID. Each entry of this table corresponds to the EMS a4 possessed by the consumer a3. When the EMS a4 is registered in the consumer cooperation support apparatus a1, the corresponding entry is created. When the EMS a4 is removed, the corresponding entry is also removed.

FIG. 6 illustrates the format of data used when managing the history of a control request issued to a consumer. Result f1 represents the result of a control request, and time f2 and control request content f3 represent the time when a control request is issued and the content thereof, respectively. These pieces of data are managed in association with the consumer ID. Each entry of this table is added whenever the EMS a4 receives a control request.

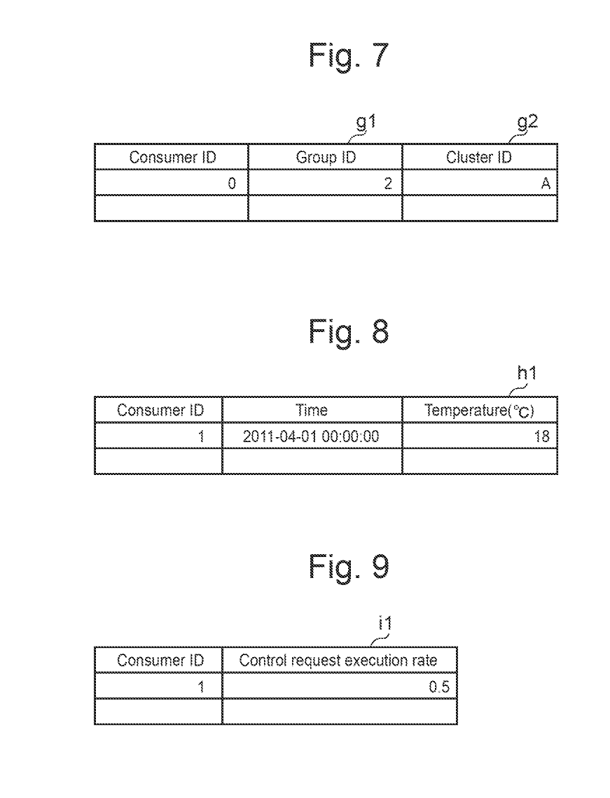

FIG. 7 illustrates the format of data used when managing a group and a cluster to which a consumer belongs. A group ID g1 is the ID of a group defined for each consumer (master consumer) that issues a control request to another consumer by its own judgment to procure electric power. A cluster ID g2 is the ID indicating the result of clustering performed based on properties such as the amount of facilities possessed by the consumer or the result of response to a control request.

The group to which respective consumers belong is managed in association with the group ID g1, and the properties of respective consumers are managed by the cluster ID g2. Each entry of this table corresponds to the EMS a4. When the EMS a4 is registered in the consumer cooperation support apparatus a1, the corresponding entry is created. When the EMS is removed, the entry is also removed.

FIG. 8 illustrates the format of data used for managing environment information on an environment of a place where a consumer is present. Temperature h1 is an example of an index indicating the environment around a consumer, and these elements are managed in association with a consumer ID and time. Each entry of this table is created whenever environment information around the consumer a3 is transmitted from the EMS a4.

FIG. 9 illustrates the format of data used when managing analysis results. A control request execution rate i1 is a value indicating whether control is executed or not when a control request is issued to a consumer. Each entry of this table corresponds to the EMS a4. The entry is created when the EMS a4 is registered in the consumer cooperation support apparatus a1 and is removed when the EMS is removed.

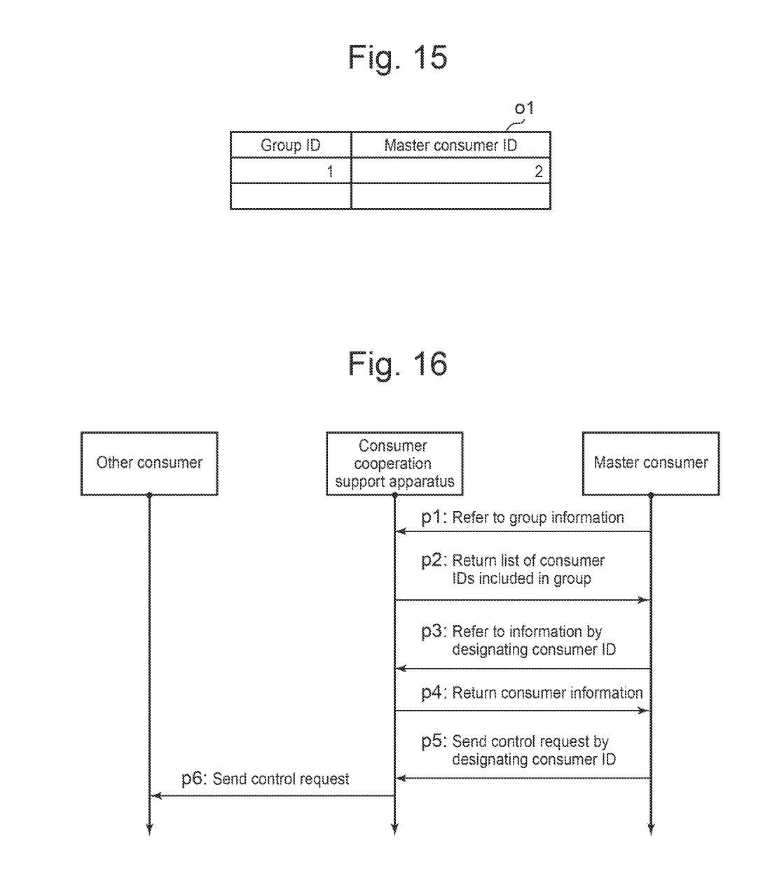

FIG. 15 illustrates the data format of the group data used when managing groups. A master consumer ID o1 is the ID of a master consumer associated with each group. Each entry of this table corresponds to a consumer (master consumer) that mainly issues a control request to other consumers among the consumers a3. When a consumer is registered in the consumer cooperation support apparatus a1 as a master consumer, the corresponding entry is created. When the consumer is removed, the corresponding entry is also removed.

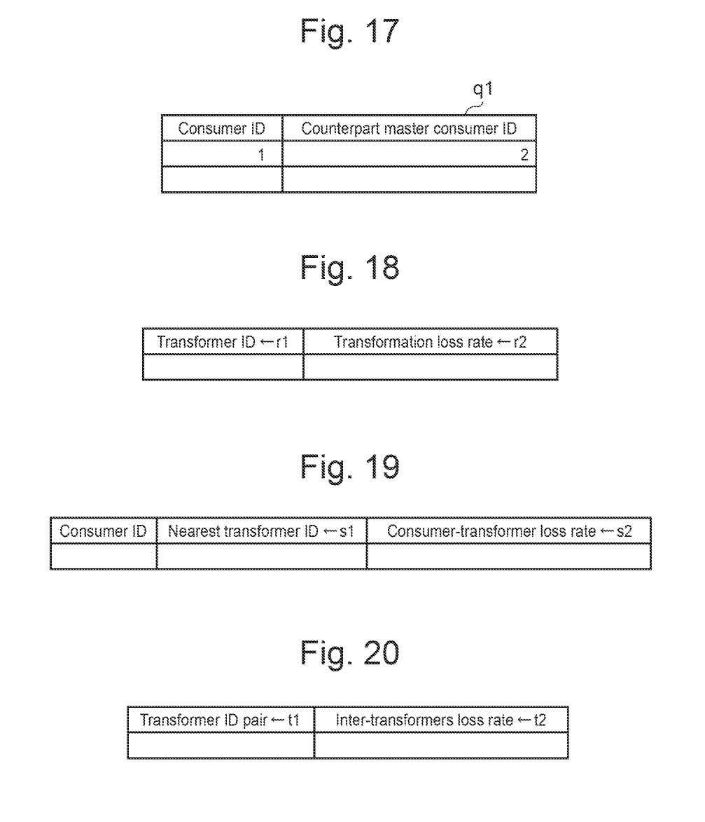

FIG. 17 illustrates the data format of contract information used for managing a correspondence of a contract between a consumer (master consumer) that mainly issues a control request and other consumers. A counterpart master consumer ID q1 is the ID of a master consumer with which the other consumers make a contract. Each entry of this table corresponds to a consumer other than the master consumer among the consumers a3. When a consumer is registered in the consumer cooperation support apparatus a1, the corresponding entry is created. When the consumer is removed, the corresponding entry is also removed.

FIG. 18 illustrates the format of data used when managing a transformer. A transformer ID r1 is the ID defined for each transformer, and a transformation loss rate r2 indicates a loss rate of electric power when transmitted via a transformer. Each entry of this table is added when a transformer is added to a power transmission and distribution network and is removed when the transformer is removed.

FIG. 19 illustrates the data format used when managing a correspondence between a consumer and a nearest transmitting transformer and a transmission power loss rate between the consumer and the transformer. A nearest transformer ID s1 indicates the ID of a transformer nearest on a transmission to a consumer, and a consumer-transformer loss rate s2 indicates a power loss rate when electric power is transmitted between a consumer and a nearest transformer. Each entry of this table is added when a consumer is added and is removed when the consumer is removed.

FIG. 20 illustrates the data format used when managing a transmission power loss rate between transformers. A transformer pair t1 indicates a pair of transformer IDs and an inter-transformer loss rate t2 indicates a transmission power loss rate between transformers. Each entry of this table is managed such that entries corresponding to an added transformer and existing transformers are added when a transformer is added to a power transmission and distribution network, and the entries corresponding to a removed transformer and the remaining transformers are removed when the transformer is removed.

Next, the details of various processes performed by the consumer cooperation support apparatus will be described.

### <Calculation of Control Request Execution Rate>

A control request execution period of each consumer is calculated according to [(accumulated control request execution period)/[(accumulated control request execution period)+(accumulated control request rejection period)]].

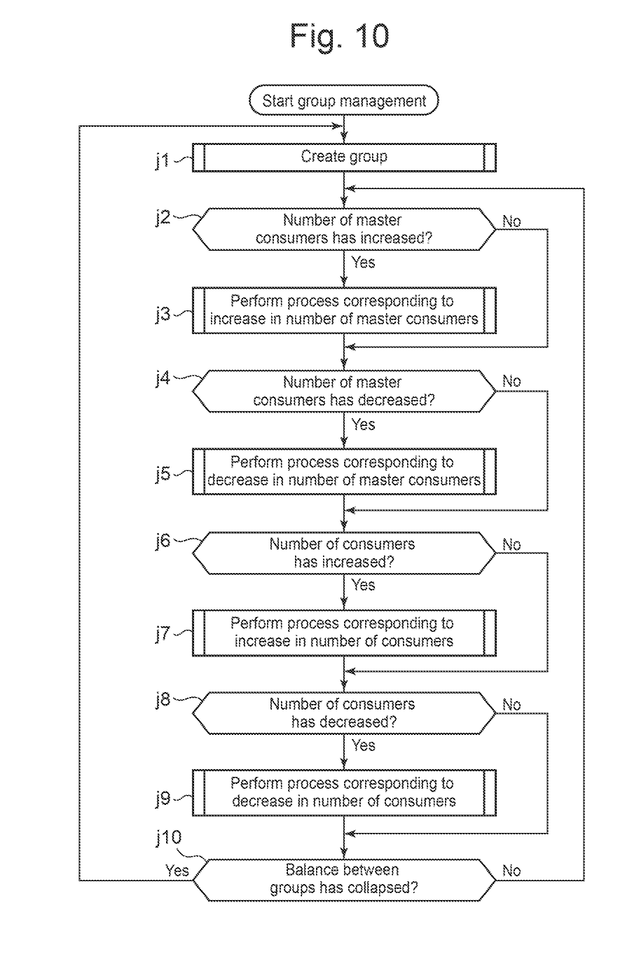

FIG. 10 illustrates an overview of a group management process. A group management processing unit of the consumer cooperation support apparatus a1 executes this process periodically to update the group information. The processes of respective steps illustrated in FIG. 10 will be described in the following paragraphs.

<Creation of Group>: Corresponds to Step j1 of FIG. 10

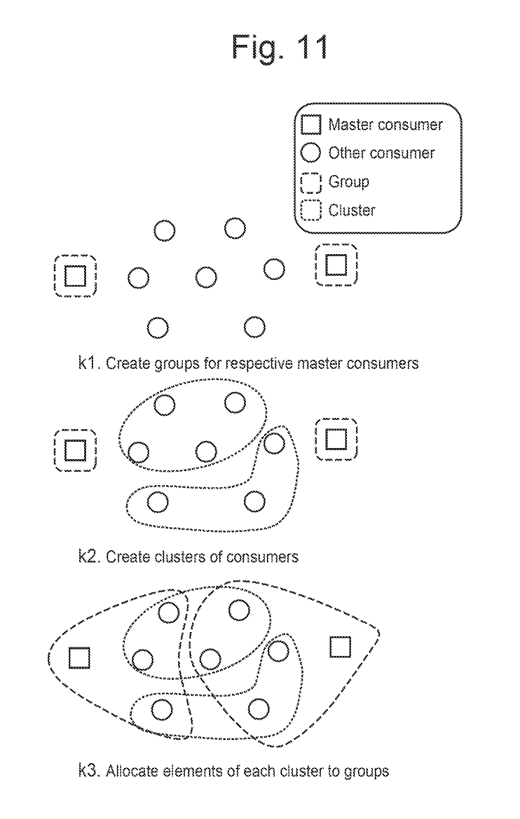

FIG. 11 illustrates an image of a group creation process. The details of this process will be described appropriately by referring to drawings.

(1) In step k1, groups are created for respective master consumers. A group ID is created for respective master consumers and a pair of a master consumer and a group ID is registered in the table illustrated in FIG. 15. An entry corresponding to a master consumer is created in FIG. 15, and the range of values that the g1 can take is determined.
(2) In step k2, consumers other than a master consumer are clustered using a method such as K-means or vector quantization based on the values managed in FIGS. 4, 5, 8, and 9. As a result, the value of the entry g2 of FIG. 7 corresponding to each consumer is determined. Moreover, by doing so, consumers having similar properties are included in each cluster.
(3) In step k3, the consumers included in each cluster are allocated to each group using an equalizing method such as round-robin. As a result, the value of the entry g1 of FIG. 7 corresponding to each consumer is determined. Moreover, by allocating consumers included in each cluster to groups using the equalizing method, the consumers allocated to each group have similar properties.
<Updating of Group Information when Number of Master Consumers Increases>: Corresponds to Steps j2 and j3 of FIG. 10

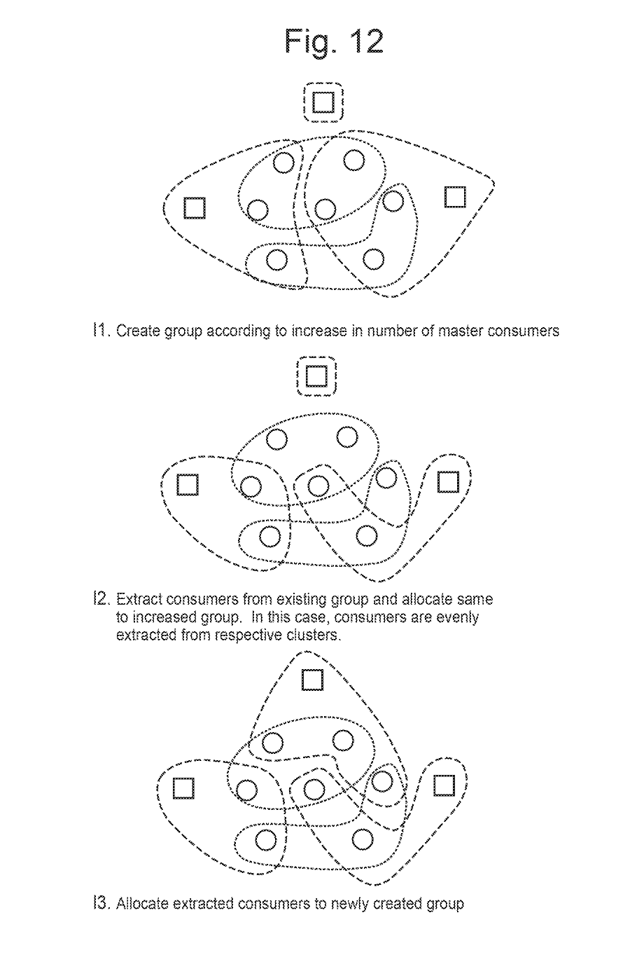

FIG. 12 illustrates an image of a group information updating process when the number of master consumers increases. The details of this process will be described appropriately by referring to drawings.

(1) In step 11, a new group is created according to an increase in the number of master consumers. An entry corresponding to the added master consumer is created in FIG. 15 and the range of values that the g1 can take increases.
(2) In step 12, some of the consumers allocated to existing groups are extracted and are allocated to a new group. In this case, a number of consumers corresponding to a proportion [(number of original master consumers)/(number of new master consumers)] among the consumers belonging to the same cluster of each group are extracted.
(3) In step 13, the consumers extracted in step 12 are allocated to the newly added master consumer. The value of the entry g1 of FIG. 7 corresponding to the extracted consumer is changed to the new group ID created in step 11.
<Updating of Group Information when Number of Master Consumers Decreases>: Corresponds to Steps j4 and j5 of FIG. 10

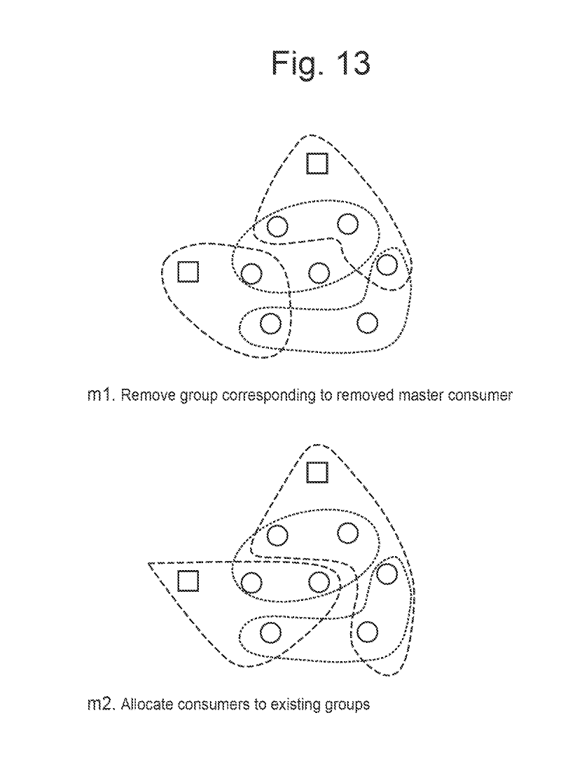

FIG. 13 illustrates an image of a group information updating process when the number of master consumers decreases. The details of this process will be described appropriately by referring to drawings.

(1) In step m1, a group corresponding to a removed master consumer is removed. The entry corresponding to the removed master consumer in FIG. 15 is removed.
(2) In step m2, consumers defined by the two values of the group ID g1 and the cluster ID g2 of the removed master consumer are divided by the number of remaining master consumers and are allocated to respective master consumers, and the group IDs g1 of respective consumers are updated.
<Updating of Group Information when Number of Consumers Increases>: Corresponds to Steps j6 and j7 of FIG. 10

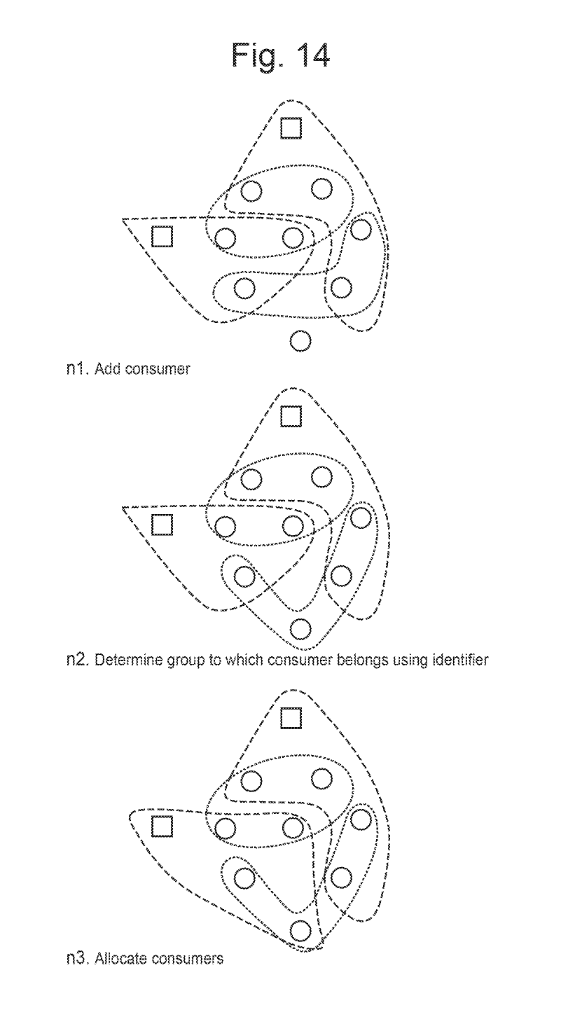

FIG. 14 illustrates an image of a group information updating process when the number of consumers increases. The details of this process will be described appropriately by referring to drawings.

(1) In step n1, a consumer is added. The entries of FIGS. 4, 5, 6, 7, 8, and 9 are created for the added consumer.
(2) In step n2, the cluster ID g2 of the consumer is determined using the identifier created in step k2.
(3) In step n3, the number of consumers included in the previously determined cluster ID g2 is compared with the number of consumers included in a group determined by an optional group ID g1, and the group ID g1 of a group including the smaller number of consumers is set to the group ID g1 of the added consumer.
<Updating of Group Information when Number of Consumers Decreases>: Corresponds to Step j8 and j9 of FIG. 10

Consumers are removed as they are. The corresponding entries of FIGS. 4, 5, 6, 7, 8, and 9 are removed.

<Reexamination of Allocation>: Corresponds to Step j10 of FIG. 10

When an event corresponding to any one of the following conditions occurs, a processing unit that has detected the event asks the group management processing unit c11 to create a group, and allocation is reexamined.

(1) The estimate and the result for a control request issued by a master consumer are different continuously, and the control request relay processing unit c8 detects the continuity.
(2) It is determined that total amounts of facilities of consumers allocated to respective master consumers, which are periodically checked by the group management processing unit, are greatly different from each other.

### <Relay of Control Request>

FIG. 16 illustrates the sequence of a process when the consumer cooperation support apparatus relays a control request from a master consumer. The details of this process will be described appropriately by referring to drawings.

(1) In step p1, an EMS of a master consumer issues an acquisition request to the consumer cooperation support apparatus in order to acquire a list of IDs of consumers belonging to a group to which the master consumer itself belongs. The consumer ID allocated to the master consumer itself is sent as a key. Consequently, the consumer cooperation support apparatus retrieves the corresponding group ID from the table of FIG. 15 stored therein, extracts an entry having the group ID g1 which is the same as the retrieved group ID among the entries of the table of FIG. 7, and returns the entry to the master consumer.
(2) In step p2, the consumer cooperation support apparatus generates a list of company IDs based on the data managed in the table of FIG. 7 and returns the list to the master consumer.
(3) In step p3, the master consumer issues an acquisition request to the consumer cooperation support apparatus in order to acquire the data of other consumers using the consumer ID as a key. In this case, the data referred to is the data managed in the table illustrated in FIGS. 4, 5, 6, 8, and 9.
(4) In step p4, the consumer cooperation support apparatus returns the data referred to from the master consumer if the consumer cooperation support apparatus has the data. If the consumer cooperation support apparatus does not have the data, the apparatus returns the fact thereof.
(5) In step p5, the master consumer determines a consumer to which a control request is to be sent based on the data obtained in step p4 and transmits a control request using the ID of the consumer as a key.
(6) In step p6, the consumer cooperation support apparatus relays the control request to send the same to respective consumers.

### Embodiment 2

Next, a case where group information is given from an external device when creating initial groups will be described as a second embodiment of the present invention. In this embodiment, it is assumed that information on a predetermined relation such as a contract relation between a master consumer and a consumer is reflected on the creation of groups. Redundant description of portions overlapping with those of the first embodiment will not be provided, and only the difference will be described.

### <Creation of Group>

In step k3, consumers are allocated to respective groups based on the data illustrated in FIG. 17. Respective consumers are allocated to a group corresponding to a master consumer designated by a counterpart master consumer ID q1. By doing so, it is possible to reflect contract information when creating initial groups.

### Embodiment 3

Next, a case where a distance-based index defined between consumers is taken into consideration when reexamining allocation will be described as a third embodiment of the present invention. In this embodiment, it is assumed that features such as a transmission power loss rate, which are dependent on a positional relation of consumers in the real world and the topology of a power transmission network are reflected on the reexamination of allocation. Redundant description of portions overlapping with those of the first embodiment will not be provided, and only the difference will be described.

### <Reexamination of Allocation>

When an event corresponding to any one of the following conditions occurs, a processing unit that has detected the event asks the group management processing unit c11 to create a group, and allocation is reexamined.

(1) The estimate and the result for a control request issued by a master consumer are different continuously, and the control request relay processing unit c8 detects the continuity.
(2) It is determined that total amounts of facilities of consumers allocated to respective master consumers, which are periodically checked by the group management processing unit, are greatly different from each other.

### <Exchange of Consumers>

(1) A pair of groups including an excess group in which a total amount of facilities possessed by allocated consumers is larger than the facilities possessed by the master consumer and a shortage group in which the total amount of facilities is smaller than the facilities possessed by the master consumer is selected.
(2) A consumer, among the consumers included in the excess group, from which the transmission distance to the shortage group is the smallest is selected and is moved to the shortage group. In this case, as the transmission distance between the consumer moved from the excess group and the shortage group, the distance between the moved consumer and a consumer, among the consumers included in the shortage group, from which the transmission distance to the moved consumer is the smallest is used. Moreover, the distance d between consumers is calculated by the following equation when the IDs of two consumers are x and y.

d(x,y)=s2(x)*r2(s1(x))*t2(s1(x),s1(y))*r2(s1(y))*s2(y)

Here, s2(x) is a consumer-transformer loss rate included in an entry retrieved from the table illustrated in FIG. 19 using a consumer ID x. s1(x) is a nearest transformer ID included in the entry retrieved from the table illustrated in FIG. 19 using the consumer ID x. r2(s1(x)) is a transformation loss rate included in an entry retrieved from the table illustrated in FIG. 18 using the transformer ID s1(x). t2(s1(x),s1(y)) is an inter-transformer loss rate included in the entry retrieved from the table illustrated in FIG. 20 using the pair of transformer IDs s1 (x) and s1(y).

(3) The process (2) is performed repeatedly until a difference between a proportion of facilities possessed by the master consumer allocated to any of the groups to a total amount of facilities possessed by consumers allocated to the group and an overall proportion reaches a threshold value or smaller.
(4) The processes (2) and (3) are performed repeatedly until an excess/shortage group disappears.

### REFERENCE SIGNS LIST

a1 Consumer cooperation support apparatus
a2 Internet
a3 Consumer
a4 EMS
a5 Power generation device
a6 Power consuming device
a7 Power storage device
a8 Environment measurement sensor
b1 CPU
b2 Main Memory
b3 Storage
b4 Network Adapter
c1 Operation data
c2 Facility data
c3 Control request history data
c4 Group data
c5 Environment data
c6 Operation data collection
c7 Facility data management
c8 Control request relay
c9 Analysis
c10 Communication unit
c11 Contract data
c12 Transmission distance
d1 Consumer ID
d2 Time
d3 Power generation amount
d4 Power consumption amount
d5 Power storage amount
e1 Latitude
e2 Longitude
e3 Maximum power generation amount
e4 Maximum power consumption amount
e5 Maximum power storage amount
f1 Result
f2 Time
f3 Control request content
g1 Group ID
g2 Cluster ID
h1 Temperature
i1 Control request execution rate
o1 Master consumer ID
q1 Counterpart master consumer ID
r1 Transformer ID
r2 Transformation loss rate
s1 Nearest transformer ID
s2 Consumer-transformer loss rate
t1 Transformer ID pair
t2 Inter-transformer loss rate

1. An electric power interchange group determining method of determining a group of a plurality of specific consumers who interchange electric power from among a plurality of consumers, the method comprising:
defining, for each of the plurality of consumers, cluster information indicating an attribute of the consumer;
grouping consumers having the same cluster information among the plurality of consumers;
dividing the grouped consumers into a number of groups to be created; and
forming groups using the divided consumers.

2. An electric power interchange group determining method according to claim 1, wherein
the number of groups to be created is the number of master consumers who can send electric power interchange information, from among the consumers.

3. An electric power interchange group determining method according to claim 2, wherein
the cluster information includes information on a response rate in past electric power interchange.

4. An electric power interchanging method comprising:
interchanging electric power based on a control request from the master consumer within the group determined by the electric power interchange group determining method according to claim 2.

5. A consumer cooperation support apparatus that determines a group of a plurality of specific consumers who interchange electric power from among a plurality of consumers, the apparatus comprising:
a storage unit that includes a table defining, for each of the plurality of consumers, cluster information indicating an attribute of the consumer; and
a group management processing unit that groups consumers having the same cluster information among the plurality of consumers, divides the grouped consumers into a number of groups to be created, and forms groups using the divided consumers.

6. A consumer cooperation support apparatus according to claim 5, wherein
the number of groups to be created is the number of master consumers who can send electric power interchange information, from among the consumers.

7. A consumer cooperation support apparatus according to claim 6, wherein
the cluster information includes information on a response rate in past electric power interchange.

8. A consumer cooperation support apparatus according to claim 5, further comprising:
a control request relay processing unit that relays a control request for electric power interchange between the plurality of consumers.
